(19) United States
(12) Patent Application Publication
(10) Pub. No.: US 2012/0128229 A1
(43) Pub. Date: May 24, 2012

(54) IMAGING OPERATIONS FOR A WIRE BONDING SYSTEM

(75) Inventors: Paul W. Sucro, Hatfield, PA (US); Zhijie Wang, Chalfont, PA (US); Deepak Sood, New Britain, PA (US); Peter M. Lister, Warrington, PA (US)

(73) Assignee: KULICKE AND SOFFA INDUSTRIES, INC., Fort Washington, PA (US)

(21) Appl. No.: 13/293,727

(22) Filed: Nov. 10, 2011

Related U.S. Application Data
(60) Provisional application No. 61/416,540, filed on Nov. 23, 2010.

(51) Int. Cl. G06K 9/00

(52) U.S. Cl. 382/145

(57) ABSTRACT

A method of imaging a feature of a semiconductor device is provided. The method includes the steps of: (a) imaging a first portion of a semiconductor device to form a first imaged portion; (b) imaging a subsequent portion of the semiconductor device to form a subsequent imaged portion; (c) adding the subsequent imaged portion to the first imaged portion to form a combined imaged portion; and (d) comparing the combined imaged portion to a reference image of a feature to determine a level of correlation of the combined imaged portion to the reference image.

### CROSS-REFERENCE TO RELATED APPLICATION

This application claims the benefit of U.S. Provisional Application No. 61/416,540, filed Nov. 23, 2010, the contents of which are incorporated herein by reference.

### FIELD OF THE INVENTION

The present invention relates to wire bonding systems, and more particularly, to improved imaging operations for a wire bonding system.

### BACKGROUND OF THE INVENTION

In the processing and packaging of semiconductor devices, wire bonding continues to be the primary method of providing electrical interconnection between two locations within a package (e.g., between a die pad of a semiconductor die and a lead of a leadframe). More specifically, a wire bonder (also known as a wire bonding machine) is used to form wire loops between respective locations to be electrically interconnected. Wire bonds (e.g., as part of a wire loop or a conductive bump, etc) are formed using a bonding tool such as a capillary or wedge.

Wire bonding machines typically include an imaging system (e.g., an optical system). Prior to wire bonding, an imaging system may be used to perform a teaching operation whereby the position of bonding locations (e.g., the die pad locations of a semiconductor die, the lead locations of a leadframe, etc.) are taught to the wire bonding machine. The imaging system may also be used during the wire bonding operation to locate eyepoints on the devices based upon the prior teaching. Exemplary imaging elements include cameras, charged coupling devices (CCDs), etc.

FIG. 1 illustrates portions of conventional wire bonding machine 100 including bond head assembly 105 and imaging system 106. Wire bonding tool 110 is engaged with transducer 108 which is carried by bond head assembly 105. Imaging system 106 includes an imaging device (e.g., a camera, not shown) as well as objective lens 106a and other internal imaging lenses, reflecting members, etc. First optical path 106b follows first optical axis 106c below imaging system 106, and is the path which light follows to affect imaging system 106 and a camera therein. Bonding tool 110 defines tool axis 112. In this example tool axis is substantially parallel to, and spaced apart from, first optical path axis 106c by x-axis offset 114. Imaging system 106 is positioned above workpiece 150 (e.g., a semiconductor die on a leadframe) to image a desired location. Workpiece 150 is supported by support structure 152 (e.g., a heat block of machine 100). Bond plane 154 extends across upper surface 156 of workpiece 150 and is generally perpendicular to tool axis 112. Bond head assembly 105 and imaging system 106 are moved along x-axis and y-axis (shown coming out of the page in FIG. 1) using an XY table or the like (not shown).

To accurately position wire bonds during the wire bonding operation, the center of an eyepoint(s) on the semiconductor device is located using the imaging system to locate positions of the bonding locations (e.g., die pads). Since the positions of the bonding locations relative to the eyepoint(s) are known from the teaching process (in a taught process), by later locating the position(s) of the eyepoint(s) one also knows the positions of the bonding locations (in a live process). However, for various reasons, the eyepoint may not be within the FOV of the imaging system, or may only partially be within the FOV of the imaging system, at the taught position of the eyepoint. Exemplary reasons include: (1) lack of manufacturing precision of the die surface; (2) the die not being accurately positioned on a leadframe; and (3) the leadframe not being accurately indexed, etc. Wire bonding systems typically utilize a “score” between a taught image and a live image where the score may be a percentage score, a raw score, etc., and may be accomplished using gray scale imaging or other techniques. If the live image does not meet a threshold “score” then an algorithm may be employed to search around the expected location in an attempt to locate the eyepoint entirely within a single FOV of the imaging system. FIGS. 2-3 illustrate examples of conventional techniques to locate an eyepoint in such circumstances.

In a conventional technique in FIG. 2, it is desired to locate eyepoint 200/teach box 201 within a single FOV. Initially, the imaging system images FOV area 202 (i.e., the position where the teaching process indicated eyepoint 200 should be located). Using a scoring system, the wire bonding machine determines the absence of eyepoint 200 in FOV area 202. Thus, the imaging system moves from FOV area 202 to FOV area 204 (with overlap 222), and then to FOV area 206 (with overlaps 224). The imaging system then moves to image FOV area 208 (with overlaps 226, 228), and a determination is made that eyepoint 200 is located entirely within FOV area 208. Overlaps 222, 224, 226, 228 are small relative to the size of the FOV areas.

In another conventional technique in FIG. 3, larger overlaps are provided between adjacent FOVs. Initially, the imaging system images FOV area 302 in an attempt to image eyepoint 300 within a single FOV, and a determination is made that no part of eyepoint 300 is within FOV area 302. The imaging system moves from FOV area 302 to FOV area 304 (with overlap 322), and then to FOV areas 306, 308 (having only a portion of eyepoint 300), 310, and 312 as shown (with the corresponding overlaps) until a determination is made that all of eyepoint 300 is within FOV area 312. Since larger overlap areas are used the probability that a single FOV area will include all of eyepoint 300 is increased; however, such a process may be more time consuming than the process of FIG. 2. Regardless, the methods of FIGS. 2-3 may result in a situation where an eyepoint is not efficiently located within a single FOV area.

Thus, it would be desirable to provide improved imaging operations for a wire bonding machine.

### SUMMARY OF THE INVENTION

According to an exemplary embodiment of the present invention, a method of imaging a feature of a semiconductor device is provided. The method includes the steps of: (a) imaging a first portion of a semiconductor device to form a first imaged portion; (b) imaging a subsequent portion of the semiconductor device to form a subsequent imaged portion; (c) adding the subsequent imaged portion to the first imaged portion to form a combined imaged portion; and (d) comparing the combined imaged portion to a reference image of a feature to determine a level of correlation of the combined imaged portion to the reference image.

According to another exemplary embodiment of the present invention, a method of imaging a wire loop of a semiconductor device is provided. The method includes the steps of: (a) imaging a first portion of a wire loop to form a first imaged portion; (b) imaging a subsequent portion of the wire loop to form a subsequent imaged portion; and (c) adding the first imaged portion to the subsequent imaged portion to form a combined imaged portion.

According to another exemplary embodiment of the present invention, a method of imaging a semiconductor device is provided. The method includes the steps of: (a) imaging a portion of a semiconductor device to form an imaged portion; (b) imaging a subsequent portion of the semiconductor device to form a subsequent imaged portion; (c) adding the subsequent imaged portion to the imaged portion to form a combined imaged portion; and (d) repeating steps (b) through (c) until the combined imaged portion includes an image of an entire side of the semiconductor device.

According to another exemplary embodiment of the present invention, a method of imaging a plurality of portions of a semiconductor device is provided. The method includes the steps of: (a) selecting portions of a semiconductor device to be imaged, each of the selected portions including at least one feature, and at least one of the selected portions being non-contiguous with others of the selected portions; (2) imaging each of the selected portions to form a plurality of selected imaged portions; and (3) saving each of the plurality of selected imaged portions to form a saved combined imaged portion.

According to another exemplary embodiment of the present invention, a method of imaging a feature of a semiconductor device is provided. The method includes the steps of: (a) imaging a first portion of a semiconductor device to form a first imaged portion; (b) comparing the first imaged portion to a reference image of a feature to determine a level of correlation of the first imaged portion to the reference image; (c) selecting a subsequent portion of the semiconductor device based upon the level of correlation of the first imaged portion to the reference image; (d) imaging the selected subsequent portion of the semiconductor device to form a subsequent imaged portion; and (e) comparing the subsequent imaged portion to the reference image of the feature to determine a level of correlation of the subsequent imaged portion to the reference image.

According to another exemplary embodiment of the present invention, a method of imaging a feature on a semiconductor device is provided. The method includes the steps of: (a) imaging separate portions of a semiconductor device having a feature to form separate imaged portions; (b) combining the separate imaged portions into a combined imaged portion; (c) saving the combined imaged portion to form a saved combined imaged portion; and (d) comparing the saved combined imaged portion to a stored reference image of the feature to establish a level of correlation between the saved combined imaged portion and the stored reference image to determine if the feature is imaged within the saved combined imaged portion.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 is a front view of a portion of a conventional wire bonding machine;

FIGS. 2-3 are schematic, top down views of conventional imaging methods;

FIG. 4 is a flow diagram illustrating a method of performing an imaging operation in accordance with an exemplary embodiment of the present invention;

FIG. 5A is a flow diagram illustrating another method of performing an imaging operation in accordance with another exemplary embodiment of the present invention;

FIGS. 5B-5F are schematic, top down views of imaging methods according to various exemplary embodiments of the present invention;

FIG. 6A is a flow diagram illustrating a method of performing an imaging operation in accordance with another exemplary embodiment of the present invention;

FIGS. 6B-6C are a schematic, top down views of imaging methods according to various exemplary embodiments of the present invention;

FIGS. 7A-7B are flow diagrams illustrating methods of performing an imaging operation in accordance with various embodiments of the present invention;

FIGS. 7C is a schematic, top down view of an imaging method according to another exemplary embodiment of the present invention;

FIG. 8A is a flow diagram illustrating a method of performing an imaging operation in accordance with another exemplary embodiment of the present invention;

FIG. 8B is a schematic, top down view of a semiconductor device useful in explaining an imaging operation according to another exemplary embodiment of the present invention;

FIG. 9A is a flow diagram illustrating a method of performing an imaging operation in accordance with another exemplary embodiment of the present invention;

FIG. 9B is a schematic, top down view of a semiconductor device useful for explaining an imaging operation according to another exemplary embodiment of the present invention;

FIG. 10 is a flow diagram illustrating a method of performing an imaging operation in accordance with another exemplary embodiment of the present invention;

FIG. 11 is a schematic, top down view of an imaging method according to yet another exemplary embodiment of the present invention;

FIG. 12A is a flow diagram illustrating a method of determining wire sway in accordance with an exemplary embodiment of the present invention; and

FIG. 12B is a schematic, top down view of bonded wires useful for explaining a method of determining wire sway in accordance with an exemplary embodiment of the present invention.

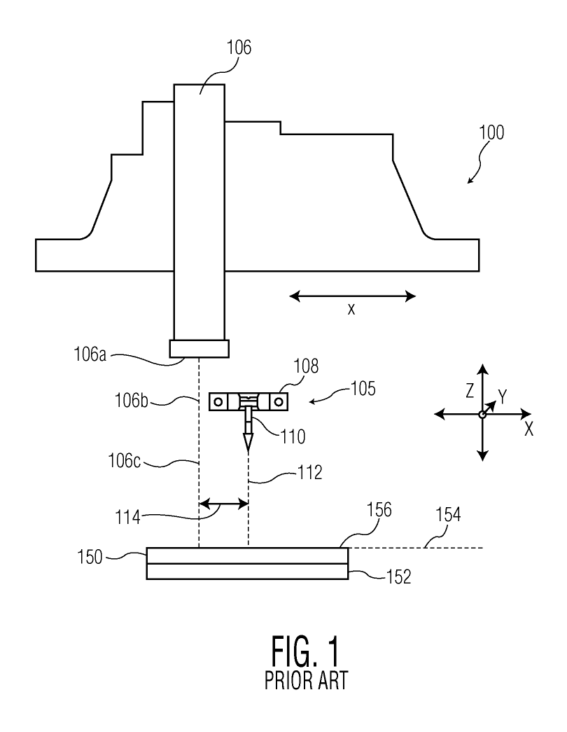

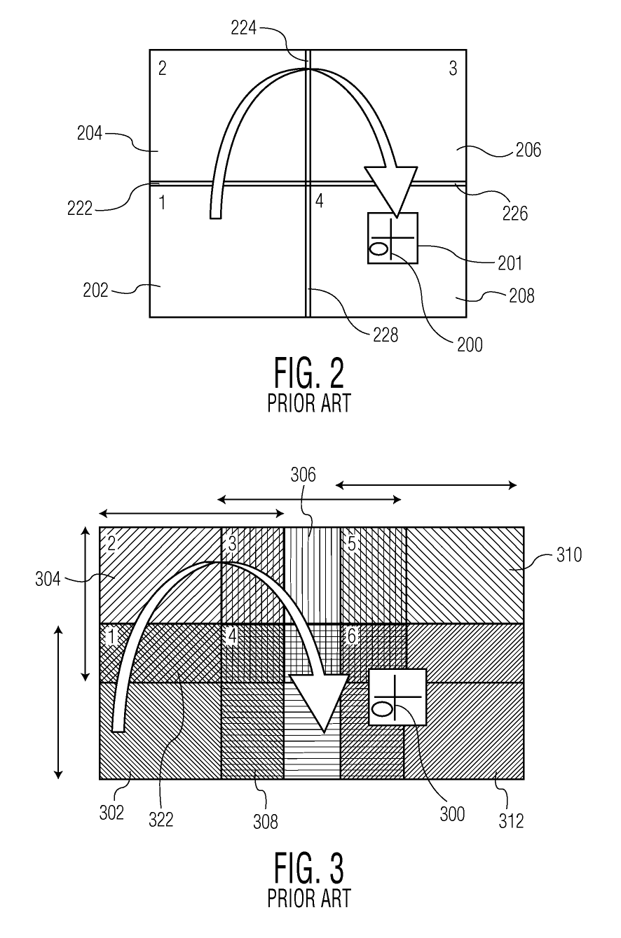

### DETAILED DESCRIPTION OF THE INVENTION

As used herein, the term “eyepoint” is intended to refer to a feature, structure, or indicia present on a device (e.g., a semiconductor device, leadframe, etc.) which may be used to determine a relative location between the eyepoint and another location of the device (e.g., a die pad of the device, another portion of the device, a portion of the wire bonding machine, etc.). An eyepoint may include other proximate indicia or features. An eyepoint may be within a “teach box” and/or may be referred to as a “teach box”. It is noted that the terms “eyepoint” and “teach box” may be used interchangeably unless otherwise noted.

As used herein, the term “field of view” (“FOV”) is the area sensed, imaged, or seen by a camera or the like (e.g., a CCD device) in a single image.

As used herein, the term “correlation” is a relationship between a feature within an imaged portion (or combined imaged portion) and a taught image of the feature. A method such as a gray scale may be used to correlate the imaged feature within a (combined) imaged portion to the taught image of the feature.

As used herein, the term “feature” is some indicia on a semiconductor device (e.g., any indicia on the device including on a die, a leadframe, a wire loop, etc.) that is desired to be imaged and/or located. An example of a feature is an eyepoint, a part of an eyepoint, etc.

It is noted that a minimal amount of a feature (e.g., an eyepoint) may be required to recognize the feature. For example: at least 10 to 30% of the feature; at least 15 to 25% of the feature; or at least 20% of the feature, may need to be imaged within a single FOV (or combined FOVs) for an algorithm to recognize that portion of the feature. Further, the feature in question may also be expected to be a certain distance from any edge of the FOV area, for example, from about 5% of the length or width from the edge of the FOV area. Such edge distance may minimize any optical distortion normally expected about the periphery of the selected optics. The FOV area may have any desired shape (e.g., rectangular, round, etc.).

It has been discovered that by combining respective imaged portions to create a combined imaged portion (e.g., a mosiac) of a feature, the time used to determine the position of that feature (e.g., eyepoint) relative to a reference position may be reduced.

A combined imaged portion may include a sufficient amount of a feature (e.g., a level of correlation) as determined by a scoring method. For example, a predetermined level of at least 70% of the eyepoint, at least 75% of the eyepoint, or at least 80% of the eyepoint may be required to be contained within the combined imaged portion as compared to a reference image to locate the eyepoint. For “smart” or “enhanced” algorithms discussed herein, when a sufficient portion of an eyepoint (e.g., at least 10-30%, at least 15-25%, at least 20%, as above) is located as compared to a reference image of the eyepoint: (a) the smart algorithm may shift the imaging system to image a further portion of the eyepoint; or (b) the enhanced algorithm may shift the imaging system to image the entire eyepoint within a single FOV.

As is understood by those skilled in the art certain steps included in the various flow diagrams may be omitted, certain additional steps may be added, and the order of the steps may be altered from the order illustrated.

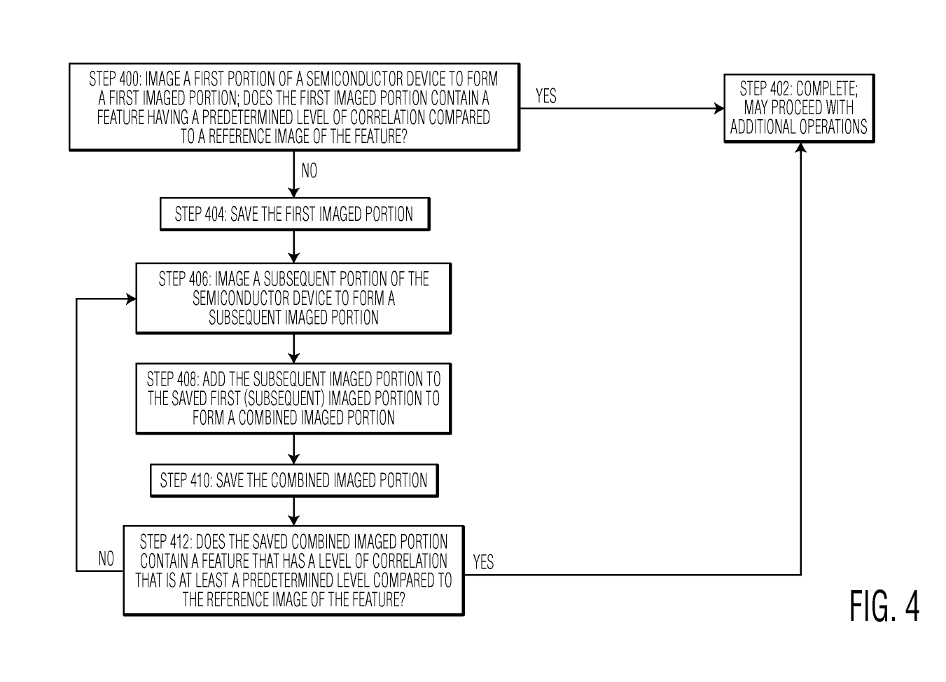

FIG. 4 is illustrates an exemplary method of forming combined imaged portions. That is, if a first imaged portion of a semiconductor device does not include a predetermined level of a feature (Step 400, “NO”), it is saved (Step 404). A subsequent portion of the device is imaged (Step 406) and added to the saved first (subsequent) imaged portion to form a combined image portion (Step 408). The combined imaged portion is saved (Step 410), and a determination is made if the saved combined imaged portion has a level of correlation that is at least a predetermined level of correlation of the reference image (Step 412). If the answer is “YES”, then the process is complete (Step 402), but if the answer is “NO”, the process returns to Steps 406 to 412 until the predetermined level of correlation of the sought for feature is achieved and the process is complete (Step 402).

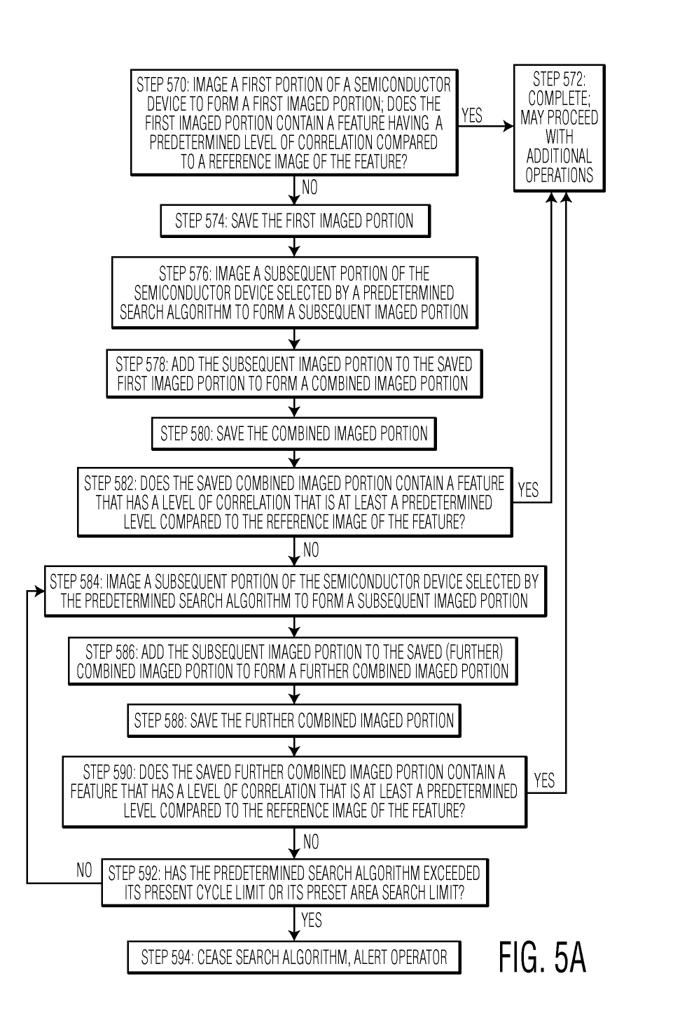

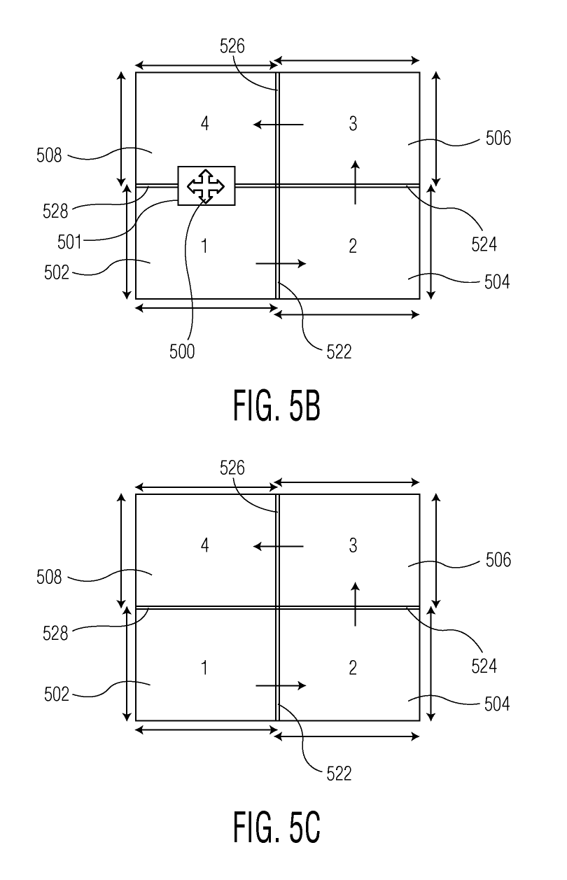

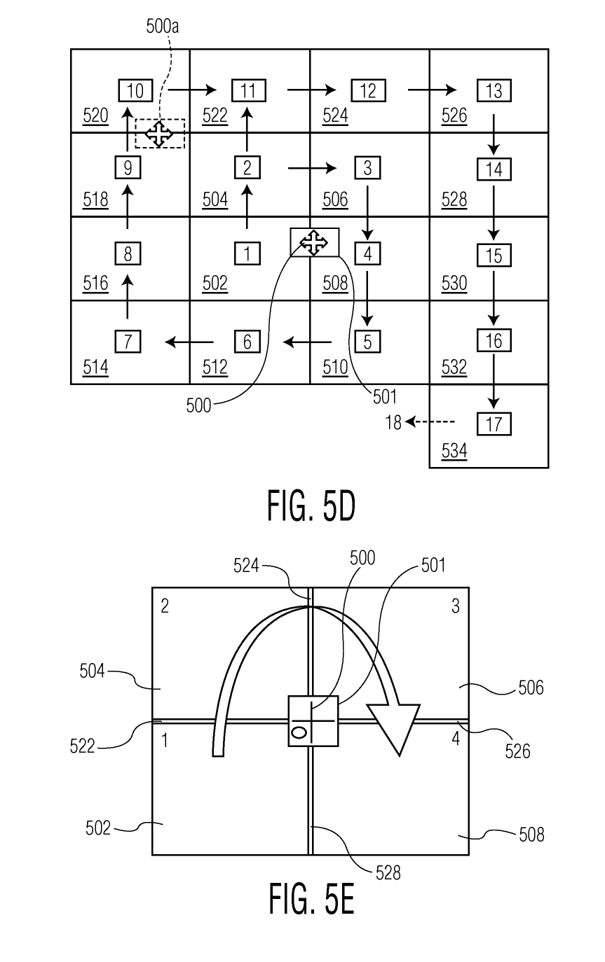

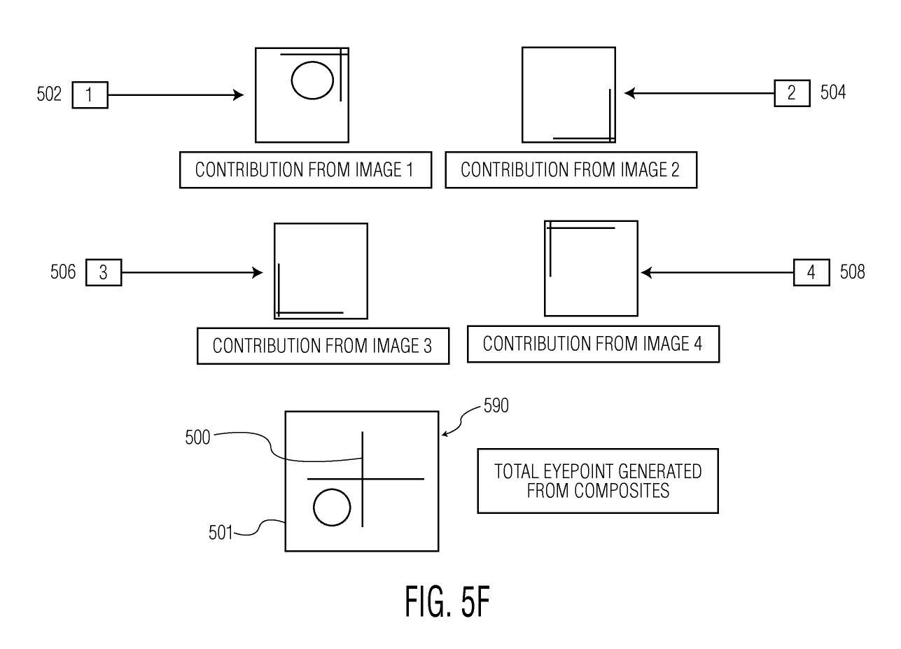

It is noted that any method disclosed herein may include a limit such as a time limit, a limit as to the number of images, or a limit as to the area within which subsequent portions are imaged. For example, a predetermined time limit may be reached, a predetermined number of imaging cycles (preset cycle limit) may be established, or a predetermined amount of area (preset area search limit) may be reached. Upon reaching such a limit, the imaging process stops, for example, to alert an operator. For example, see Steps 592 and 594 of FIG. 5A (discussed below).

Referring back to FIG. 4, it is noted that there is no specific indication of how a subsequent portion to be imaged is selected at Step 406. According to the present invention, any of a number of techniques may be used to make this selection. FIGS. 5A-5F, 6A-6C, and 7A-7C include examples of such selection techniques.

FIG. 5A illustrates another exemplary method of forming combined imaged portions wherein a subsequent portion of the semiconductor device to be imaged is determined by a predetermined technique. If a first imaged portion of a semiconductor device fails to achieve a predetermined level of correlation of a feature as compared to a reference image of the feature (Step 570, “NO”), it is saved (Step 574), and then a subsequent portion(s) of the semiconductor device to be imaged is selected by a predetermined search algorthim (Step 576). The subsequent imaged portion is added to the first imaged portion (Step 578), and the combined imaged portion is saved (Step 580) and checked to see if it contains the feature by having a level of correlation that is at least a predetermined level of correlation as compared to the reference image of the feature (Step 582). If the answer at Step 582 is “NO”, this check is repeated with a subsequent portion of the semiconductor device (Steps 584 to 590/592), until such a predetermined level of correlation of the feature as compared to a reference image of the feature is achieved (“YES” at Step 590). This continued imaging of subsequent portions may be limited by a preset cycle limit, or a preset area search limit (Step 592) at which point the search ceases and an operator is alerted (Step 594). As shown in FIG. 5A, a “YES” at any of Steps 570, 582, and 590 leads to Step 572 where the present operation is complete.

FIGS. 5B-5F illustrate schematic, top down views of other exemplary algorithms/methods of forming combined imaged portions that may correlate to the flow diagram methods of FIG. 4 and/or FIG. 5A. In FIG. 5B (and other figures) FOV areas may be shown with corresponding horizontal and vertical double headed arrows to assist in defining those respective FOV areas (including overlaps). FIG. 5B illustrates a schematic, top down view of another examplary method of forming combined imaged portions. In this exemplary method, a numerical (1 through 4) predetermined counterclockwise-spiral search algorithm is employed (FOVs 502 to 504 to 506 to 508). As illustrated, eyepoint 500/teach box 501 lies between (initial) FOV area 502 and FOV area 508. Based upon previous teaching of the device, the imaging system is positioned to image FOV area 502 (a first imaged portion) where it is expected to locate all of eyepoint 500/501. In this example, only a portion of eyepoint 500 is within initial FOV area 502 (i.e., the lower portion of eyepoint 500) and this portion is not enough to provide an adequate score to indicate that a sufficient portion of eyepoint 500 is within FOV area 502 (the initial FOV area 502 imaged portion does not contain enough of eyepoint 500 to have a predetermined level of correlation) (e.g., Step 570, “NO”). The image of initial FOV area 502 is saved to memory as the saved first imaged portion of a to-be combined imaged portion or composite image (e.g., Step 574). The imaging system is then shifted in the selected algorithm sequence from FOV area 502 to image FOV area 504 with overlap 522. The image of subsequent FOV area 504 (subsequent imaged portion) (e.g., Step 576) is combined with the saved first imaged portion (of initial FOV area 502) to form a combined imaged portion (of FOV areas 502, 504) (e.g., Step 578) which is saved to memory (e.g., Step 580) to form a saved combined imaged portion. A determination is made as to whether eyepoint 500 is now within this saved combined imaged portion (e.g., Step 582). It is not (“NO”), so the imaging system is then shifted from FOV area 504 to image FOV area 506 (with overlap 524). The image of FOV area 506 (subsequent imaged portion) (e.g., Step 584) is combined with the saved combined imaged portion to form a further combined imaged portion (of FOV areas 502, 504, 506) (e.g., Step 586) which is saved to memory (e.g., Step 588) to form a saved further combined imaged portion. A determination is again made if eyepoint 500 is within this saved combined imaged portion (e.g., Step 590). Again, it is not (“NO”), and a determination is made if the predetermined search algorithm has exceeded its preset cycle limit or its preset area search limit (e.g., Step 592). In this example, it has not (“NO”), so the imaging system is then shifted from FOV area 506 to image FOV area 508 (having the upper portion of eyepoint 500) (with overlaps 526, 528) (e.g., Step 584). The image of FOV area 508 (subsequent imaged portion) is added to the prior saved combined imaged portion to form a further combined imaged portion (of FOV areas 502, 504, 506, 508) (e.g., Step 586) and the further combined imaged portion is saved to memory (e.g., Step 588) to form another saved further combined imaged portion. A determination is made if eyepoint 500 is within this saved combined imaged portion (e.g., Step 590). It is (“YES”), so the actual location of eyepoint 500 is now known, the imaging process is complete and additional operations may now proceed (e.g., Step 572).

FIG. 5C illustrates a schematic, top down view of another exempary method of forming combined images. Compared to the example of FIG. 5B, in this method, no part of an eyepoint (or no part sufficient enough to be determined to be part of an eyepoint) is within four adjacent FOV areas 502, 504, 506, 508 having respective overlaps 522, 524, 526, 528. The imaging system is positioned to image initial FOV area 502 (i.e., the area where the eyepoint is expected to be located based upon the prior teaching). A determination is made if there is a portion of the eyepoint within initial FOV area 502 (e.g., Step 570). It is not, so the image of FOV area 502 (first imaged portion) may be saved to memory (e.g., Step 574) as the saved first imaged portion of a to-be combined imaged portion or composite image. The imaging system is shifted in the algorithm sequence (e.g., a counterclockwise spiral pattern as illustrated) from FOV area 502 to image: FOV area 504 (with overlap 522) (e.g., Step 576); then FOV area 506 (with overlap 524); then FOV area 508 (with overlaps 526, 528); with respective images taken, scored, and saved to the prior (combined) mosaic images. At this point, the algorithm may continue (e.g., from Step 592, “NO”) so that the imaging system is shifted to image another FOV area adjacent to FOV area 508 (e.g., to an FOV area that is to the immediate left of FOV area 508) (e.g., Step 584), etc., until either a determination is made that the combined imaged portion has a predetermined level of correction compared to a reference image of the feature (e.g., Steps 584-590 then Step 572), the algorithm area search limit is met (e.g., Step 592), or a preset number of search cycles for the algorithm is met or exceeded (e.g., Step 592).

FIG. 5D illustrates a schematic, top down view of another exemplary method of forming combined imaged portions. FIG. 5D illustrates the use of a clockwise spiral search algorithm beginning at imaged initial FOV area 502 (where all of eyepoint 500/teach box 501 is expected to be located from the previous teaching of the wire bonding machine) and then imaging FOV areas 504, 506 and 508 (with overlaps between adjacent imaged FOV areas not shown). Each successive image of an FOV area may be added to the prior imaged portion until a combined imaged portion (an image of FOV areas 502, 504, 506, 508) is created, and, in this example, a determination is made that the combined imaged portion has a predetermined level of correlation compared to the reference image of the feature to establish the location of eyepoint 500 (Step 590). The imaging process is thus complete (Step 572).

Further considering FIG. 5D, if eyepoint 500 was not in the position shown, but was actually positioned between, for example, FOV areas 518, 520 (shown as eyepoint 500a within a dashed line box), then, assuming no preset search limits are reached, the imaging system would continue to follow the clockwise spiral search algorithm as illustrated (to FOV area 510 and then sequentially to areas 512, 514, 516, 518 and 520) taking images of each FOV area and combining them with the prior FOV area images to form a combined (ten FOV area) imaged portion. A determination is then be made as to whether such combined imaged portion has at least a predetermined level of correlation to a reference image of the feature (e.g., eyepoint 500a). This is true (“YES”), so the process stops (Step 572). However, further considering FIG. 5D, if eyepoint 500a was also not positioned between areas 518, 520, then the search algorithm would continue to image FOV area 522 and then to image areas 524, 526, 528, 530, 532, 534 (combining the imaged FOV areas along the way) and potentially beyond as shown as dashed arrow “18” until its preset area search limit or cycle limit were reached. Upon reaching the limit the imaging system may cease operation and an operator alarm or other indicator could be activated (Step 594).

FIGS. 5E-5F illustrate schematic, top down views of other exemplary methods of forming combined images. As illustrated in FIG. 5E, eyepoint 500/teach box 501 is approximately centered between four adjacent FOV areas 502, 504, 506, 508. FIG. 5E illustrates a schematic, top down view of the progress of a spiral, clockwise search algorithm, and FIG. 5F illustrates the individual saved first imaged portion (of initial FOV area 502) and the (three) subsequent imaged portions (of FOV areas 504, 506, 508) and the saved combined imaged portion showing composite image 590 of eyepoint 500/501. Based upon prior teaching of the device, the imaging system is positioned to image a location expected to include all of eyepoint 500, that is, initial FOV area 502. A portion of eyepoint 500 is within initial (first) FOV area 502, and the image of initial FOV area 502 is saved to memory as the first imaged portion of a to-be combined imaged portion or composite image. The imaging system is then shifted: to image FOV area 504 (with overlap 522 with initial FOV area 502); over FOV area 506 (with overlap 524 with FOV area 504); and then to image FOV area 508 (with respective overlaps 526, 528 with FOV area 506 and initial imaged FOV area 502) in accordance with, in this example, a clockwise search algorithm, with the combining and saving of the subsequent images of the FOV area(s) with the prior combined image(s) until a predetermined level of correlation is achieved.

FIG. 5F illustrates the individual images of FOV areas (clockwise from the upper left) as: (1) first imaged portion (of initial FOV area 502) having the lower left corner of eyepoint 500/501; (2) subsequent imaged portion (of FOV area 504) having the upper left corner of eyepoint 500/501; (3) subsequent imaged portion (of FOV area 506) having the upper right corner of eyepoint 500/501; and (4) subsequent imaged portion (of FOV area 508) having the lower right corner of eyepoint 500/501. After the first imaged portion and the (three) subsequent imaged portions are combined into saved combined imaged portion 590, the predetermined level of correlation between saved combined imaged portion 590 and a reference image of eyepoint 500 is achieved and a combined image of eyepoint 500 results. (For ease of understanding, each image of FOV areas 502, 504, 506, 508 illustrated in FIG. 5F includes nonduplicative images of eyepoint 500/501.) As one skilled in the art would appreciate, overlaps 522, 524, 526, 528 (e.g., see FIG. 5E) may be provided in the adjacent portions of eyepoint 500/501 in each image of FOV areas 502, 504, 506, 508.

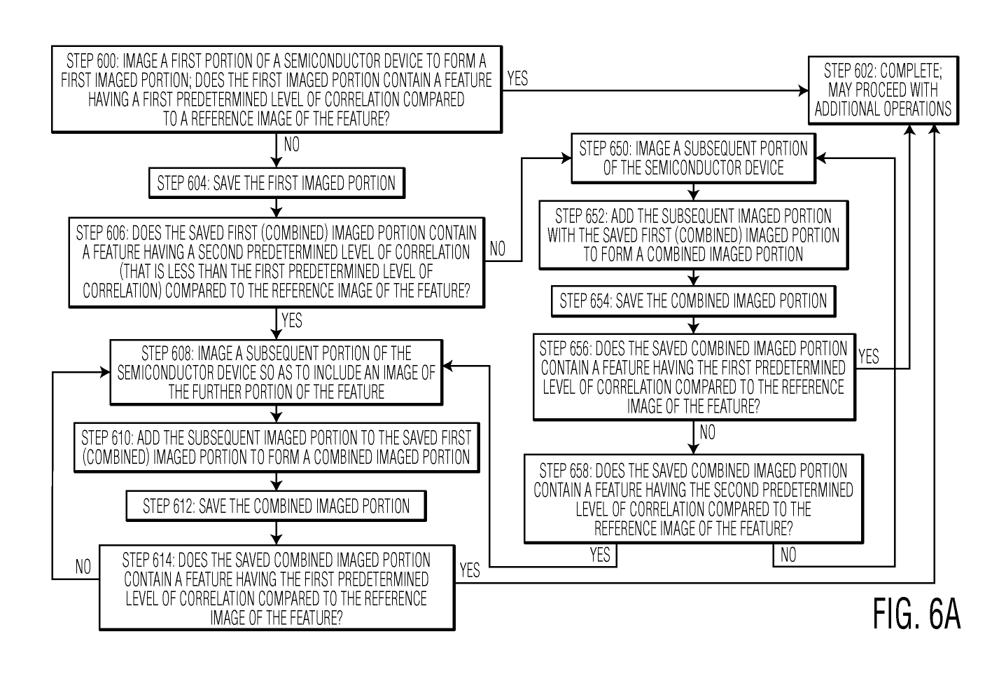

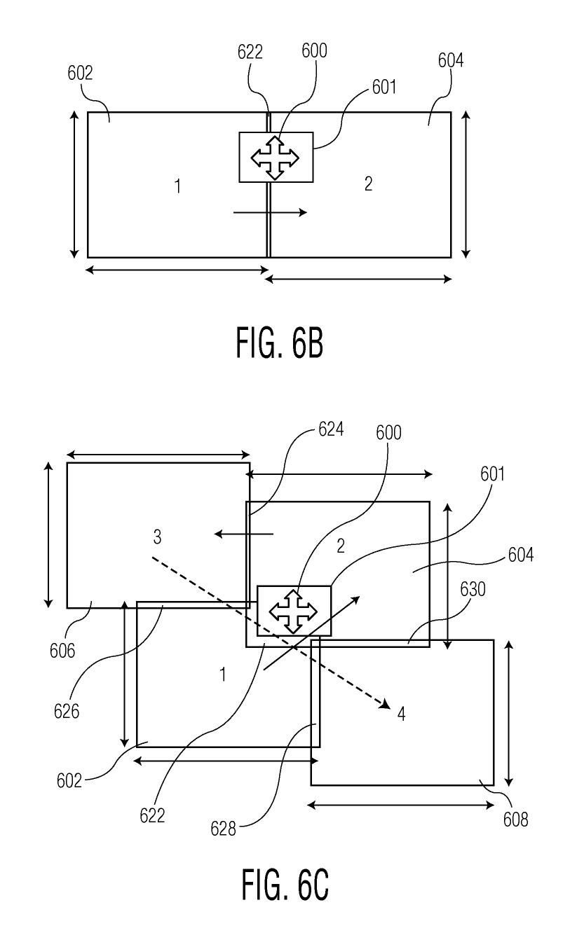

FIG. 6A illustrates another exemplary method of forming combined imaged portions wherein a subsequent portion of the semiconductor device to be imaged is determined by a “smart” search algorithm. For example, a smart search algorithm determines which portion, if any, of a feature of a semiconductor device is within a saved first imaged portion (or combined imaged portion) whereby an imaging system is moved to include an image of a further portion of the feature (or possibly the entire feature). If the first imaged portion of a semiconductor device does not include a first predetermined level of a feature (e.g., all of the feature) (Step 600), it is saved (Step 604) and then checked against a second predetermined level of the feature (lower than the first level, e.g., a part of the feature) (Step 606). If the first imaged portion does include the first predetermined level of the feature (Step 600), the process is complete (Step 602) If the second predetermined level is achieved, then a subsequent portion of the device is imaged to include a further portion of the feature (Step 608), and the images are combined (Step 610) and saved (Step 612). If the combined image includes the first predetermined level of a feature (Step 614) the process is complete (Step 602); however, if it does not, a further subsequent portion of the device is imaged to include a further portion of the feature (Step 608), that is combined (Step 610) and saved with the earlier combined image (Step 612), and is compared to the first predetermined level (614). This process repeats (Steps 606-614) until the first predetermined level is achieved and the process is complete (Step 602).

However, if the first (combined) imaged portion does not include even the second pretermined level of the feature (“NO” at Step 606), then a search is instituted (Steps 650 to 658 to 650) until either the first pretermined level of the feature is found (Steps 656 to 602), or the second pretermined level of the feature is found (Steps 658 to 608).

FIGS. 6B-6C illustrate schematic, top down views of other exemplary methods of forming combined images that may correlate to the flow diagram of FIG. 6A, wherein a subsequent portion of the semiconductor device to be imaged is determined by a “smart” algorithm to include at least another portion of a desired feature imaged in previous steps. Specifically, the method of FIG. 6B endeavors to locate a feature (e.g., eyepoint 600/teach box 601) on a workpiece (e.g., a semiconductor device or a die) by constructing a combined imaged portion using a “smart” algorithm. As illustrated, eyepoint 600/601 lies between FOV area 602 and FOV area 604. Based upon prior teaching of the device, the imaging system is positioned to image initial field of view (FOV) area 602 which is expected to include all of eyepoint 600. However, only a portion of the left side of eyepoint 600 is within initial FOV area 602 (e.g., Step 600 of FIG. 6A), and this portion is insufficient (e.g., by scoring) to establish that this first imaged portion contains a feature having a first level of correlation (i.e., to include substantially all of the feature) compared to the reference image of the feature. The imaged portion of FOV area 602, with the left hand portion of eyepoint 600, is saved to memory as a saved first imaged portion (e.g., Step 604) and a smart algorithm (e.g., in the memory of the wire bonding machine) compares the saved first imaged portion to the taught reference image of eyepoint 600 to determine which portion, if any, of eyepoint 600 is within initial FOV area 602 (e.g., Step 606). In this example, the left side of eyepoint 600 is on the right edge of FOV area 602 as determined by the smart algorithm. The smart algorithm then directs the imaging system to image FOV area 604 (with a predetermined amount of overlap 622 with FOV area 602) which is expected to include a further portion of feature 600 (e.g., Step 608). The image of FOV area 604 (subsequent imaged portion with the right hand portion of eyepoint 600) is added to the saved first imaged portion of initial FOV area 602 to create a combined imaged portion (e.g., Step 610) and the combined imaged portion is saved to memory (e.g., Step 612). A determination is made if this saved combined imaged portion includes a feature having the first predetermined level of correlation compared to the saved reference image of eyepoint 600 (e.g., Step 614). If the answer is “YES”, as it is in this example, then the imaging process is complete (Step 602). If the answer at Step 614 is “NO”, then the method loops back to Step 608 and a determination is made as to whether the saved combined imaged portion includes a feature having a second predetermined level of correlation, etc. as discussed previously.

FIG. 6C illustrates a schematic, top down view of another exemplary method of forming combined imaged portions that may correlate to the flow diagram of FIG. 6A. Eyepoint 600/teach box 601 is located at the upper right hand corner of initial FOV area 602. Based upon previous teaching of the device, the imaging system is positioned to image initial FOV area 602 which is expected to include substantially all of eyepoint 600. However, only a portion of eyepoint 600 is within the image of initial FOV area 602 (the first imaged portion) (e.g., Step 600). The image of FOV area 602, including a portion of eyepoint 600, is then saved to memory (e.g., Step 602) as the saved first imaged portion of what will become a combined imaged portion or composite image. The “smart” algorithm compares the saved first imaged portion (of initial FOV area 602) to the taught reference image of eyepoint 600 to determine which portion of eyepoint 600 is within the saved first imaged portion (e.g., Step 606). Since at least a predetermined portion of eyepoint 600 is at the upper right hand corner of FOV area 602, the wire bonding machine smart algorithm recognizes the portion as being the lower left hand corner/portion of sought after eyepoint 600. The smart algorithm thus directs the imaging system to image the upper right FOV area 604 (having predetermined overlap 622 with initial FOV area 602) so as to capture a further portion of eyepoint 600 (e.g., Step 608). This places the center of eyepoint 600 approximately within overlap 622. The subsequent imaged portion of FOV area 604 is added (e.g., Step 610) to the saved first imaged portion (the image of initial FOV 602) and saved (e.g., Step 612) to form a saved combined imaged portion. The wire bonding machine compares this saved combined imaged portion (and may account for any distortion in overlap 622) to the reference image of the eyepoint 600 to determine a level of correlation between them (e.g., Step 614). Since an image of eyepoint 600 is contained within the saved combined imaged portion, the smart algorithm determines that a sufficient first level of correlation is achieved and that the imaging process is complete (e.g., Step 602).

Now, consider FIG. 6C as if the smart algorithm were unable to obtain a combined imaged portion that included a sufficient level or correlation compared to a reference image of eyepoint 600 after combining images of initial FOV area 602 and FOV area 604 (e.g., Step 614 of FIG. 6A). Then the imaging system may be shifted to image FOV area 606 (with overlaps 624, 626), and then to image FOV area 608 (with overlaps 628, 630), imaging each FOV area 606, 608 in turn, and adding those images to the saved combined imaged portion to form a sufficient composite image of eyepoint 600 to meet the first level of correlation, if not the second level of correlation (e.g., Steps 606, 608, 610, 612, 614).

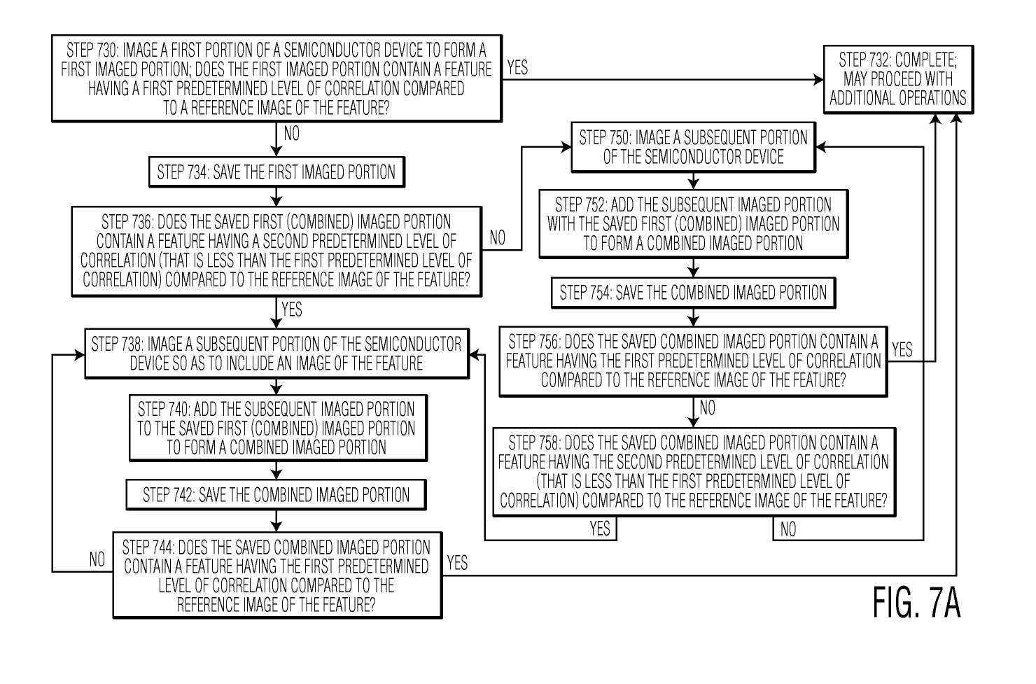

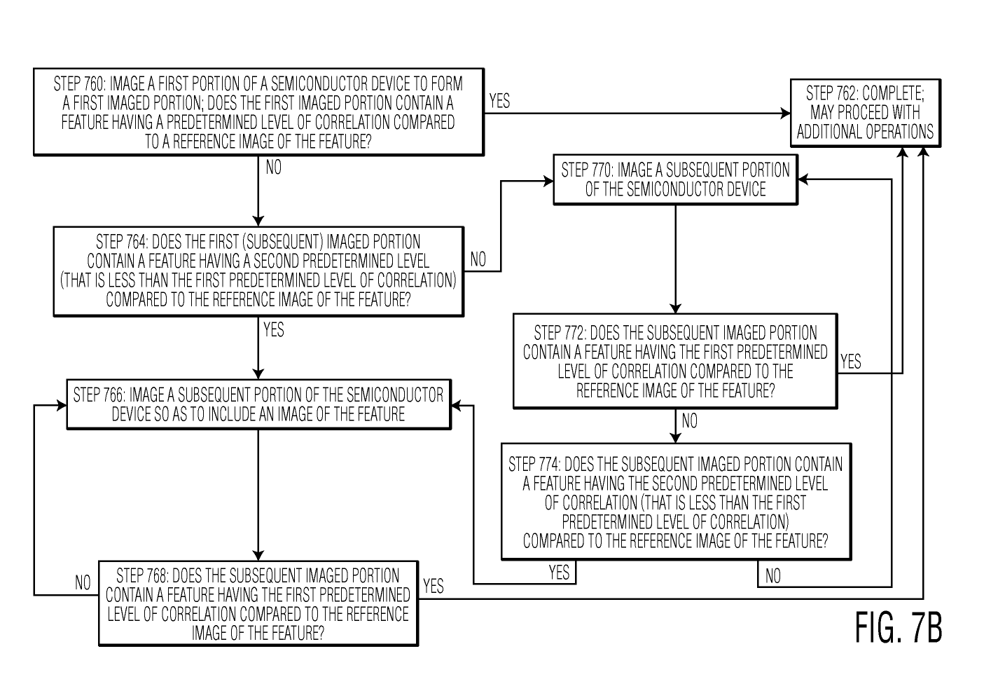

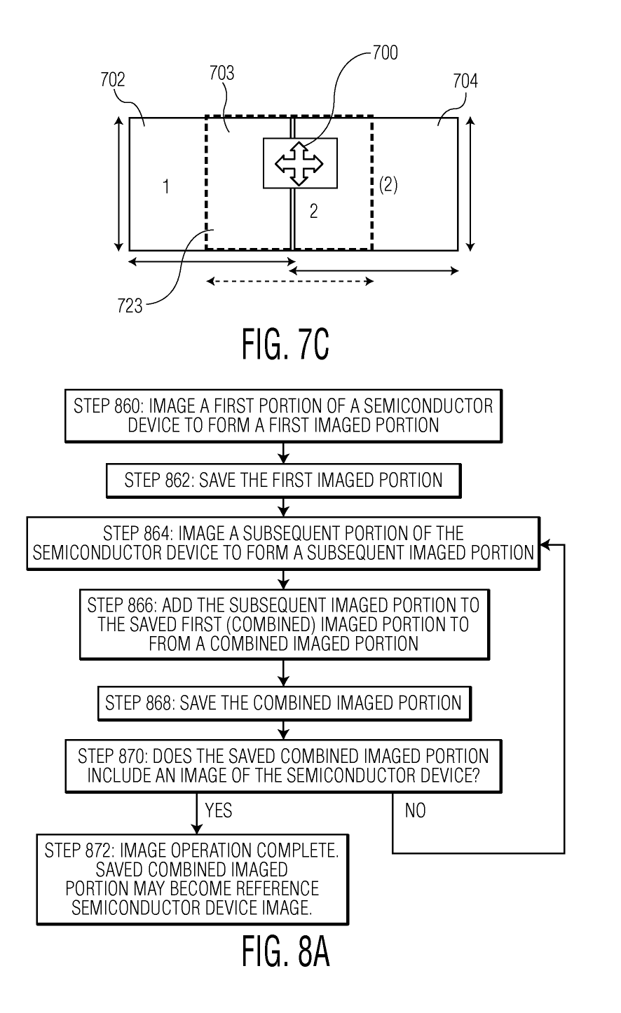

FIG. 7A illustrates another exemplary method of forming combined imaged portions wherein a subsequent portion of the semiconductor device to be imaged is determined by an enhanced search algorithm. That is, an enhanced algorithm not only determines which portion (if any) of a feature is within a saved first imaged portion/a saved combined imaged portion, but is also able to determine what subsequent FOV area should include an image of the feature (i.e., all of the feature based a “first predetermined level” of the selected scoring system) in the next/subsequent imaged portion. If a first imaged portion contains a first level of correlation (Step 730, “YES”) the process proceeds to Step 732 and is complete. If the first imaged portion does not contain the first level of correlation (Step 730, “NO”), then the first imaged portion is saved (Step 734) and a determination is made if the saved first imaged portion has the second level of correlation (Step 736) (i.e., whether the first imaged portion includes a part of the image of the feature). If “YES” at Step 736, the enhanced algorithm directs that a subsequent portion of the semicondutor device be imaged that includes the image of the feature (Step 738). The images are combined and saved (Steps 740-742) and a determination is made as to whether the saved combined image portion has the first level of correlation (i.e., it includes all of the feature) (Step 744). If yes (Step 744, “YES”) the process is complete (Step 732). If no (Step 744, “NO”), the process loops back to Step 738, etc.

If the saved first (or combined) imaged portion does not have the second predetermined level of correlation, then the method proceeds to Steps 750 to 758 until: (1) the saved combined imaged portion contains a feature having the first level of correlation (Step 756) and the process is complete (Step 732); (2) the saved combined imaged portion contains a feature having the second level of correlation (Step 758) and returns to Step 738; or (3) the saved combined imaged portion does not contain a feature having the second level of correlation (Step 758) and returns to Step 750.

FIG. 7B illustrates another exemplary method of forming combined imaged portions which is analogous to the method of FIG. 7A except that each imaged portion is not combined with a previous imaged portion to form a combined imaged portion and is otherwise self-explanatory to one skilled in the art. This method may avoid the time necessary to save any such data.

FIG. 7C illustrates a schematic, top down view of another exemplary method of forming (combined) imaged portions that may correlate to the flow diagrams of FIG. 7A (combining and saving imaged portions) or FIG. 7B (neither combining, nor saving, any imaged portions). As illustrated, a feature (e.g., eyepoint 700) lies between FOV areas 702, 704. Based upon previous teaching of the device, the imaging system is positioned to image initial FOV area 702 which is expected to include all of eyepoint 700. However, all of eyepoint 700 is not within FOV area 702 and as such, a determination is made that FOV area 702 does not include a feature having a first predetermined level of correlation (e.g., Step 730/Step 760). In the FIG. 7A method, the image of FOV area 702 is saved as the saved first imaged portion of a to-be combined imaged portion or composite image (e.g, Step 734). As noted above, the FIG. 7B method skips all combining and saving steps. A determination is made that the imaged portion includes about 45% of feature/eyepoint 700 (e.g., Step 736/Step 764), specifically a left hand portion shown in FIG. 7C. Because this level of correlation (e.g., 45%) is greater than the second predetermined level (Step 736/764, “YES”), the enhanced algorithm then directs the imaging system to image FOV area 703 that includes feature/eyepoint 700 in FIG. 7C (to the right of FOV area 702) (e.g., Step 738/Step 766). FOV area 703 is shown in bold dashed lines in FIG. 7C, and includes overlap 723 with initial FOV area 702. In the method of FIG. 7A, the image of FOV area 703 is added to the saved first imaged portion to form a combined imaged portion (of FOV areas 702, 703) (e.g., Step 740) and the combined imaged portion is saved (e.g., Step 742) (to form a saved combined imaged portion). In the method of FIG. 7B, subsequent FOV area 703 is considered separately, and is not combined with FOV area 702. A determination is then made that the combined imaged portion of FIG. 7A (or the subsequent imaged portion of FIG. 7B) includes an image of eyepoint 700 having the first level of correlation as compared to a reference image of the eyepoint (e.g., Step 744/Step 768) and the search process is complete (e.g., Step 732/Step 762). Since the center of eyepoint 700 is approximately in the center of FOV area 703, there is minimal or no distortion about the center of eyepoint 700 so the center may be (more) accurately determined.

One or more exemplary methods of forming combined imaged portions of a feature may also be employed to form a combined imaged portion of a feature/features that exceed(s) the size of any single FOV area. That is, the combined imaged portion may not simply include just one or more features of a semiconductor device sized to fit within a single FOV, but may include selected sections, a large portion of the semiconductor device, or essentially, the entire semiconductor device.

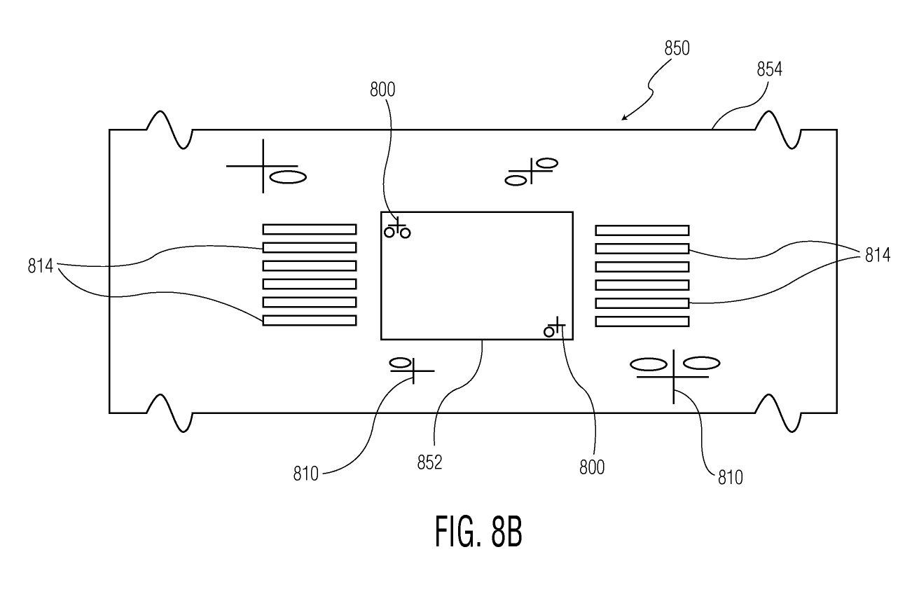

FIG. 8A illustrates another exemplary method of forming combined imaged portions. In the example, a combined image is created of essentially an entire semiconductor device (or a selected portion thereof). At step 860, a first portion (e.g., an FOV area) of a semiconductor device is imaged to form a first imaged portion, and at Step 862 the first imaged portion is saved (to form a saved first imaged portion). At Step 864, a subsequent portion of the semiconductor device is imaged to form a subsequent imaged portion, and at Step 866 the subsequent imaged portion is added to the saved first imaged portion to form a combined imaged portion. At Step 868 the combined imaged portion is saved (to form a saved combined imaged portion). At Step 870, a determination is made if the saved combined imaged portion includes an image of the semiconductor device (based upon predetermined criteria). If “YES” then the imaging operation is complete, and the saved combined imaged portion may become the reference semiconductor device image (Step 872). If “NO” then steps 864 to 870 are repeated until the saved combined image includes an image of the semiconductor device. The image of the device may be, for example, an entire image of the device on a given side (i.e., the upper exposed surface of the device which may be viewed by the imaging system). Endless looping between Steps 864 and 870 may be avoided, for example, using a maximum time, a maximum number of iterations, maximum image area, etc.

FIG. 8B illustrates semiconductor device 850 including die 852 (having respective die eyepoints 800) supported by support substrate 854 (having respective eyepoints 810 and leads 814). An imaging system images a first portion of semiconductor device 850 to establish an initial (first) FOV image. An image is taken of the first portion (first FOV area) to form a first imaged portion (Step 860 of FIG. 8A). The first imaged portion is saved (Step 862). An algorithm may be used to move the imaging system to image another, second portion (subsequent FOV area) of device 850. This second portion is imaged to form a subsequent imaged portion (Step 864). The subsequent imaged portion is added to the first imaged portion to form a combined imaged portion (Step 866). The combined imaged portion is saved (Step 868). A determination is made as to whether the combined imaged portion includes an image of the entire (or predetermined portion of) semiconductor device 850 (Step 870). If “NO” the imaging system moves according to the predetermined search algorithm to image another subsequent portion (FOV area) of device 850, and that subsequent third portion is imaged to form a third (another) imaged subsequent portion (Step 864). The third imaged subsequent portion is added to the prior combined imaged portion to form another combined imaged portion (Step 866) and that combined imaged portion is saved (Step 868). The imaging system continues to move in accordance with the search algorithm to image subsequent portions (FOV areas that may include overlaps) that are added to the prior combined imaged portions until the entire (or predetermined portion of) semiconductor device 850 is imaged (e.g., if “YES” at Step 870 proceed to Step 872). Thus, the combined imaged portion including semiconductor device 850 may become a semiconductor device reference image (i.e., the prior teaching of the semiconductor device) (e.g., Step 872). If desired, only a predetermined portion of semiconductor device 850 may be imaged to form the semiconductor reference image. It is contemplated that the FOV areas may be imaged (and saved, or not) in any order.

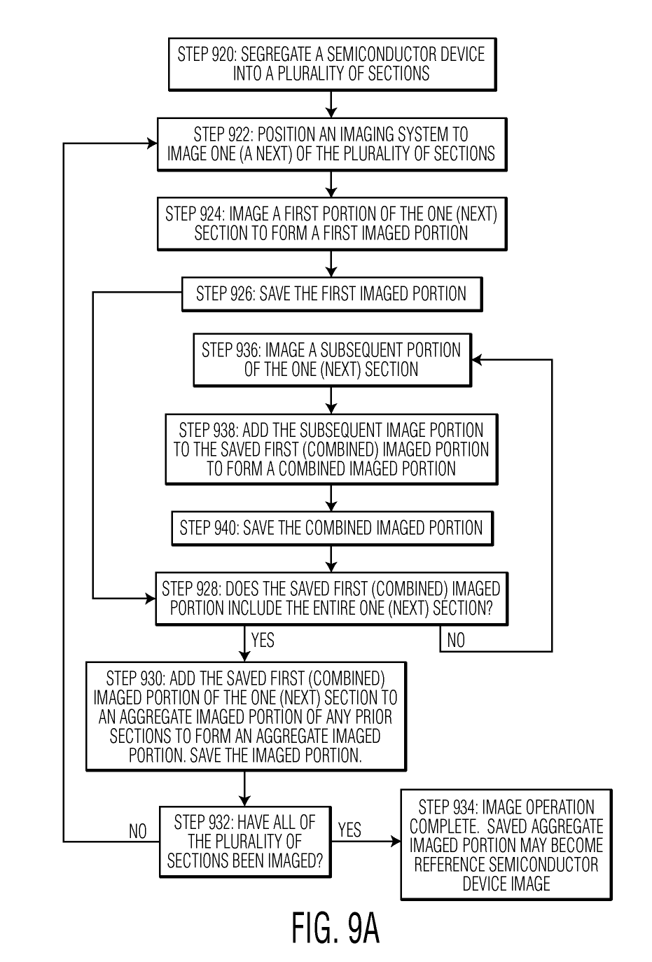

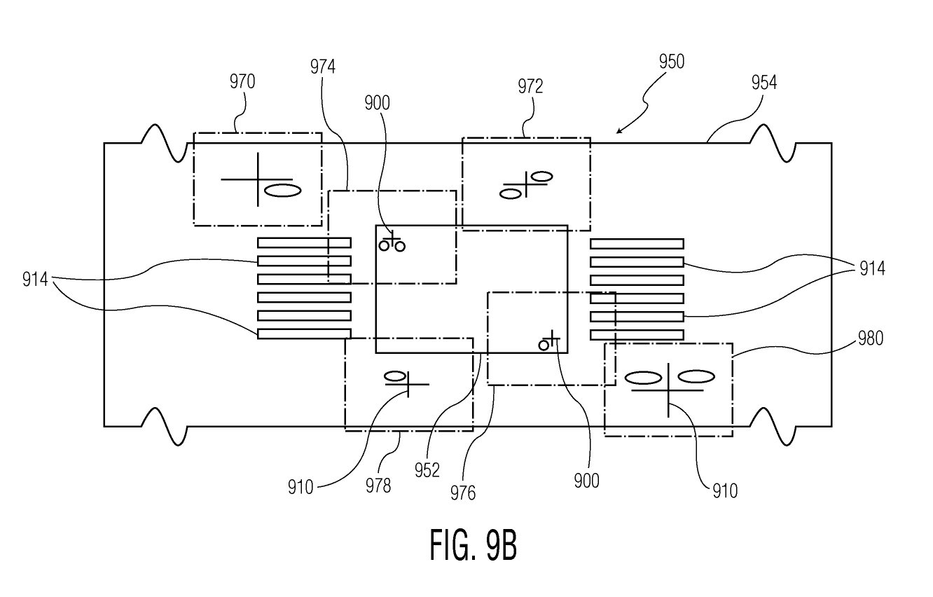

FIG. 9A illustrates another exemplary method of forming combined imaged portions. The selected sections of the combined image may (or may not) correspond to FOV areas that are contiguous with one another. A semiconductor device is segregated into a plurality of sections (Step 920) and an imaging system is positioned and images (Steps 922-924) one of the plurality of sections. The imaged portion is saved (Step 926) and a determination is made if the saved imaged portion includes the entire section (Step 928). If “NO” the method proceeds to Steps 936-940 (described below). If “YES” the saved imaged portion is added to an aggregate imaged portion of any prior sections to form an aggregate imaged portion (Step 930). If all of the plurality of sections of the device have been imaged (Step 932, “YES”), then the image operation is complete, and the saved aggregate imaged portion may become a reference semiconductor device image (Step 934). If not (Step 932, “NO”) then the process returns to Step 922, etc., until all of the plurality of sections have been imaged. If at Step 928 it is determined that the saved imaged portion does not include all of the relevant section (e.g., the relevant section is not entirely within the imaged FOVs) a subsequent portion is imaged, saved, and combined (Steps 936-940) and the determination described above is repeated at Step 928.

FIG. 9B illustrates semiconductor device 950 including die 952 (having respective die eyepoints 900) supported by support substrate 954 (having respective eyepoints 910 and leads 914. Semiconductor device 950 is segregated into sections (e.g., FOV areas 970, 972, 974, 976, 978, 980) (Step 920 of FIG. 9A) that are to be imaged to create a saved combined imaged portion (e.g., the aggregate imaged portion of Step 930). Each section may be greater than one FOV area, but, in this example, each section comprises a single FOV area 970, 972, 974, 976, 978, 980. The sections may also include other features beyond respective eyepoints 900, 910 (e.g., FOV area 976 also includes portions of several leads 914). The imaging system is positioned and images a section (e.g., Steps 922-924), for example, FOV area 970. An image is taken of FOV area 970 (first imaged portion) (e.g., Step 924) and that image is saved (e.g., Step 926) as the first saved FOV area 970 image. A determination is made if the first saved imaged portion of FOV area 970 includes the entirety of section 970 (e.g., Step 928). The answer is “YES”, and the saved FOV area 970 image initiates the aggregrate imaged portion (e.g., Step 930). A determination is made that not all of plurality of sections 970, 972, 974, 976, 978, 980 have been imaged (e.g., “NO” at Step 932), so the imaging system is shifted to imaging a subsequent selected FOV area, for example, FOV area 972 (e.g., Step 922) according to a predetermined algorithm. An image is taken of subsequent FOV area 972 (e.g. Step 924), and the first imaged portion of section 972 is saved (e.g., Step 926). A determination is made that this first imaged portion of section 972 includes the entire FOV area 972 (e.g., “YES” at Step 928). This first imaged portion of section 972 is added to the first FOV area 970 image (in one or more data files) to form a subsequent aggregate imaged portion which is saved to memory (e.g., Step 930). Since not all of the sections have been imaged yet (e.g., “NO” at Step 932), the imaging system is then shifted to image selected FOV area 974, for example, and this process continues for the remainder of select FOV areas 974, 976, 978, 980 (using Steps 936 - 940 as necessary for each FOV area). After all of the FOV areas have been imaged (e.g., “YES” at Step 932), this final aggregate imaged portion (of select FOV areas 970, 972, 974, 976, 978, 980) may then become a reference semiconductor device 950 image for a subsequent process, such as a bonding process (e.g., see Step 934).

The methods illustrated in FIGS. 8B and 9B may be applied to different parts of a semiconductor device as desired. Examples of composite images that may be formed using these methods include: a semiconductor die alone; a semiconductor die and a portion of a substrate supporting the die, such as leads of a leadframe; an entire a semiconductor device including a semiconductor die and its supporting substrate; eyepoints/teachboxes of a semiconductor die and/or supporting substrate, amongst others.

When a wire bonding operation is stopped (e.g., an unintended interruption such as a machine assist, a scheduled interruption, etc.), it may be possible to automatically determine where the imaging system (and thus a bonding tool) is positioned relative to the semiconductor device/workpiece by taking a single snapshot of the device within the imaging system's FOV area. That snapshot image of the FOV area may then be compared with the stored reference image of the complete device (e.g., see FIG. 8B), or of select portions of the device (e.g., see FIG. 9B), to determine a unique position of the imaging system/bonding tool relative to the device.

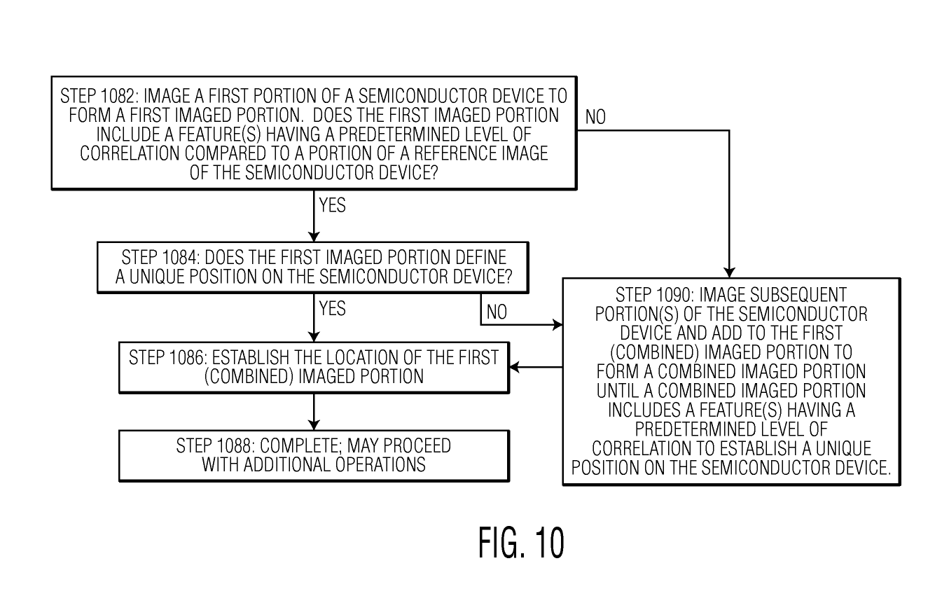

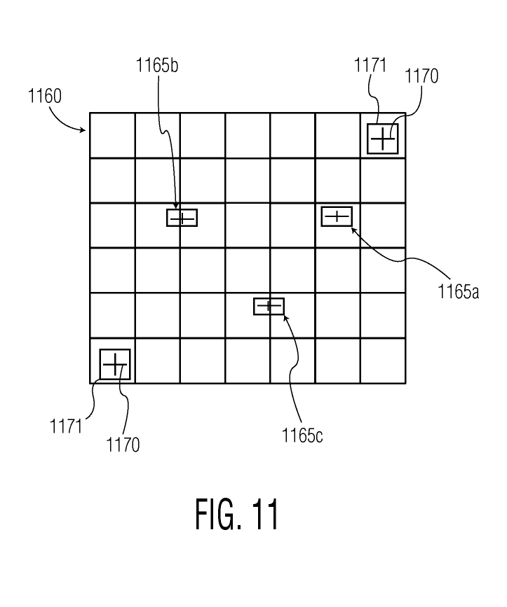

Once a unique position is determined, the bonding operation, for example, may continue using that unique position as a reference point. As described below in conjunction with FIGS. 10-11, in the case of aliasing effects this may provide one of two or more possible positions of the bond head of the machine.

FIG. 10 illustrates another exemplary method of forming combined imaged portions by imaging a portion of a semiconductor device in an attempt to establish a specific (e.g., unique) position on the semiconductor device. The method of FIG. 10 is explained below in conjunction with the top down block diagram view of FIG. 11 (where each of the 42 squares in the 7x6 grid in FIG. 11 represents a FOV). In the method illustrated in FIG. 10 the reference image (i.e., the aggregate imaged portion referred to in Step 1082) may be analogous to: (a) the combined imaged portion obtained from a method like FIG. 8A; or (b) the aggregate imaged portion obtained from a method like FIG. 9A.

Suppose that it is desired to locate the upper right eyepoint 1170/1171 in FIG. 11 (and not the lower left eyepoint 1170/1171). The area where this upper right eyepoint 1170/1171 is expected to be is imaged (Step 1082 of FIG. 10). If the first imaged portion does not meet the level of correlation of a feature of a reference image (e.g., the aggregate imaged portion) (“NO” at Step 1082) the process proceeds to Step 1090. If the answer at Step 1082 is “YES” the process proceeds to Step 1084. Then a determination is made at Step 1084 as to whether that feature (which met the predetermined level of correlation at Step 1082) defines a “unique” position on the device. This determination needs to be made because ceratin features may occur more than one time one a device (i.e., they are aliases of one another). In this example, the answer at Step 1084 is “NO” because based on the scoring system the upper right eyepoint 1170/1171 and the lower left eyepoint 1170/1171 are substantially the same (i.e., they are aliases of each other) and a unique position can not be established.

Regardless of how the process proceeds to Step 1090 (either a “NO” from Step 1082 or a “NO” from Step 1084), additional portion(s) of the device are imaged and added to the first (or combined) imaged portion to form a combined imaged portion. This process of Step 1090 continues until the combined image portion has the predetermined level of correlation to establish the unique position of the upper right eyepoint 1170/1171. For example, feature 1165a is imaged and established as being in a positional relationship to the upper right hand eyepoint 1170, 1171. While device 1160 includes other features 1165b, 1165c (which are substantially similar to feature 1165a), these other features do not have the same positional relationship to upper right eyepoint 1170/1171 as does feature 1165a. Thus, the predetermined level of correlation is met and a unique positon is established for upper right eyepoint 1170/1171 (Steps 1090 and 1086) and this portion of the process is complete (Step 1088).

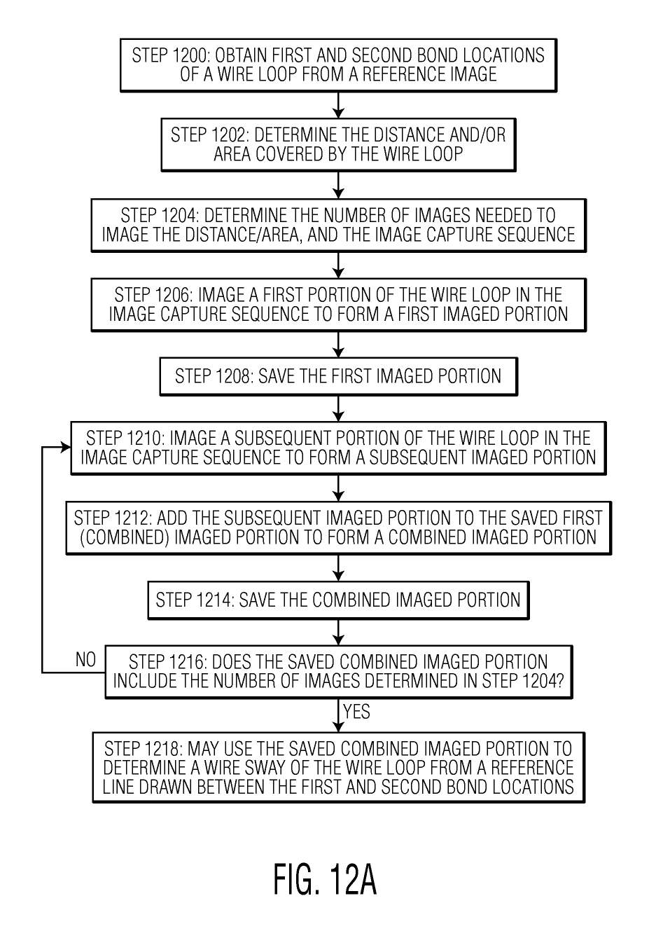

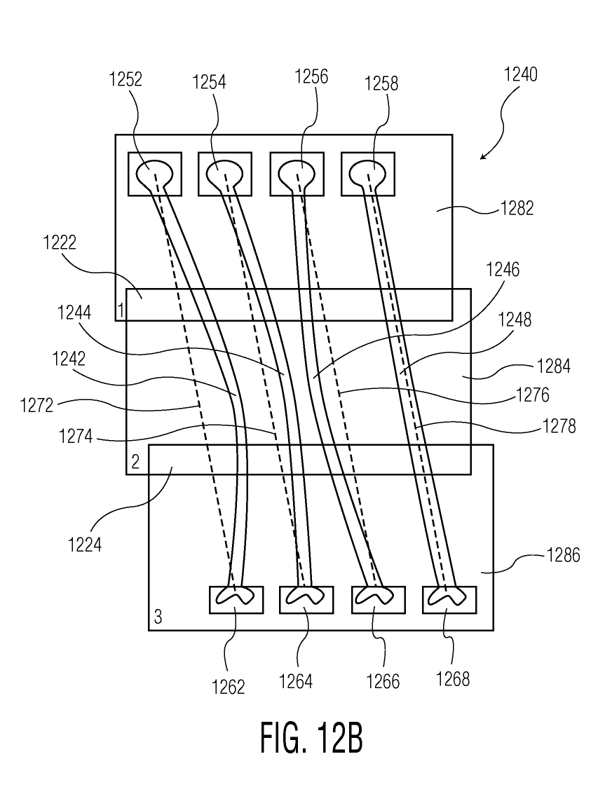

FIG. 12A is a flow diagram illustrating an exemplary method of measuring the wire sway of one or more wire loops by forming a combined imaged portion of the wire loops. At step 1200, first and second bond locations of a wire loop(s) are obtained from a reference image. At step 1202, the distance and/or area covered by the wire loop(s) are determined (e.g., by calculating or otherwise determining the distance/area). At step 1204, the number of images utilized to image the distance/area, and the sequence in which the number of images will be captured (the image capture sequence), are determined. In step 1206, using the image capture sequence, a first portion of the wire loop is imaged to form a first imaged portion, and in step 1208, the first imaged portion is saved. In Step 1210, a subsequent portion of the wire loop is imaged to form a subsequent imaged portion. In Step 1212, the subsequent imaged portion is added to the saved first (or combined) imaged portion to form a combined (or further combined) imaged portion, and in Step 1214, the combined imaged portion is saved. In Step 1216 a determination is made if the saved combined imaged portion includes the number of images determined in Step 1204. If the answer is no, then, steps 1210 to 1216 are repeated. If the answer is yes, then the method proceeds to Step 1218 where the saved combined imaged portion may be used to determine (e.g., calculate) a wire sway of each wire loop using a reference line drawn between the respective first and second bond locations of the wire loop.

FIG. 12B illustrates a plurality of wire loops useful for explaining the method of FIG. 12A. A wire loop, when viewed from above, may follow an essentially straight line (reference line) from a center of its first bond to a center of its second bond, and wire sway is the amount a wire loop deviates from that reference line. Excessive wire sway is undesirable, as it may lead to short circuiting and other problems. Wire loop assembly 1240 includes wire loops 1242, 1244, 1246, 1248 that are each bonded between: (a) respective first bonds (e.g., ball bonds) 1252, 1254, 1256, 1258; and (b) respective second bonds (e.g., stitch bonds) 1262, 1264, 1266, 1268. Reference lines 1272, 1274, 1276, 1278 connect: (a) the center of respective first bonds 1252, 1254, 1256, 1258; and (b) the center of respective second bonds 1262, 1264, 1266, 1268. A wire loop measurement algorithm may be initiated (e.g., by a wire bonding machine) and the first and second bond locations of each wire loop 1242, 1244, 1246, 1248 may be obtained from a reference image based upon a prior teaching operation (e.g., Step 1200). The distance and/or area covered by the collective wire loops to be imaged is determined (e.g., Step 1202). Using information such as the size, orientation, and area covered by the FOV of the imaging system used, the number of images used to image the total distance/area, and the image capture sequence, are determined (e.g., Step 1204).

For example, the image capture sequence may begin at one end of the wire loops (e.g, with the first or second bonds) and proceed along the length of the wire loops until the other end of the wire loops is imaged. In a specific example, the imaging system may image first FOV area 1282 (including first bonds 1252, 1254, 1256, 1258) to create a first imaged portion (e.g., Step 1206) which may be saved to memory (e.g., Step 1208). Subsequent FOV area 1284 is then imaged (which may include overlap 1222) to create a subsequent imaged portion (e.g., Step 1210). The imaged portion of subsequent FOV area 1284 is added to the saved first imaged portion (of FOV area 1282) to form a combined imaged portion that may be saved to memory (e.g., Steps 1212 and 1214). A determination is made if the number of images determined in Step 1204 have been taken (i.e., have all portions of the wire loop(s) been imaged in the combined imaged portion) (e.g., Step 1216). If the desired wire loop(s) have not been imaged (“NO” at Step 1216), another cycle of Steps 1210 to 1216 begins. FOV area 1286 is then imaged (as determined by the image capture sequence from Step 1204), where the image of area 1286 includes second bonds 1262, 1264, 1266, 1268 (which may include overlap 1224) (e.g., Step 1210). The imaged portion of subsequent FOV area 1286 is added to the prior combined imaged portion to form a subsequent (final) combined imaged portion (of FOV areas 1282, 1284, 1286) (e.g., Step 1212 and 1214). A determination is made if the (final) combined imaged portion includes the number of images determined in Step 1204 (e.g., Step 1216). If “YES”, as in this example, the imaging is complete as the final combined imaged portion should now include the entire length of each of wire loops 1242, 1244, 1246, 1248. In one example, overlaps 1222, 1224 between adjacent FOV areas may be from about 5 to 30% of each respective FOV area 1282, 1284, 1286.

The wire sway of each wire loop 1242, 1244, 1246, 1248 may then be determined/calculated (e.g., Step 1218) from this saved (final) combined imaged portion of wire loop assembly 1240 by comparing the distance each wire loop 1242, 1244, 1246, 1248 is spaced from respective reference lines 1272, 1274, 1276, 1278. That is, the combined imaged portion may be used to determine the wire sway (e.g., the maximum wire sway) for each wire loop 1242, 1244, 1246, 1248 using an image processing algorithm or the like. Such an algorithm may sample multiple points on the wire that are compared to respective reference lines 1272, 1274, 1276, 1278 at corresponding points. Such final combined imaged portion may also be displayed on a visual display (e.g., a computer monitor of the wire bonding machine) so that an operator may use such a display to determine the wire sway and/or its acceptablity. For example, the operator may visually determine the wire sway on the display. In another alternative, an algorithm may accept input from the operator (e.g., marking the maxium wire sway, marking the reference line, etc.) in order to determine the wire sway and/or whether the wire sway is acceptable.

It is noted that the imaging operations of FIGS. 12A-12B may extend beyond imaging in the XY plane as shown in FIG. 12B. For example, it may be desirable to image the wire loops along other axes. In one example, the wire loops may be imaged to generate a side view (e.g., along the z-axis). Further still, imaging may be provided along axes other than the Cartesian axes (i.e., other than along XYZ directions). In any event, the various images taken may be combined to generate 3-dimensional images of the wire loops (or other portions of the device). Such 3-dimensional images may be used for any of a number of purposes such as, for example, to measure wire loop sagging, wire loop humping, etc.

In one specific example, the wire loop image data may be used in a wire loop height measurement process. For example, by taking side view images of the wire loops, the profile of each wire loop may be imaged, thereby allowing for the determination of the wire loop height (e.g., by an operator viewing the image on a visual display, by an algorithm, etc.). Of course, such techniques may also be used to determine other characteristics of wire loops such as wire loop sag, wire loop humping, clearance between the wire loop and the die edge, etc.).

As provided above, the imaged portions/combined imaged portions of the various examplary methods of the present invention may be displayed on a visual display (such as a computer monitor of the wire bonding machine) for inspection or observation by an operator.

Also, using OCR (optical character recognition) software or the like, identification of semiconductor devices may be made by reading the identifying digit sequence or other identifying indicia, where such indicia may be imaged (or later identified) according to the techniques disclosed herein.

In any of the methods of combining images described herein, it will be appreciated that the various images generated for use in a combined imaged portion may be spaced as desired. For example, in the generation of a combined imaged portion, the various methods may utilize: (1) overlaps between adjacent imaged portions (FOV areas); (2) no intentional overlaps between adjacent imaged portions; and/or (3) intentional gaps between adjacent imaged portions (“gapped algorithm”). Further still, these techniques may be used together. In one such example, intentional gaps may be provided between adjacent imaged portions in the generation of a first combined imaged portion. Then, no gaps (or even overlaps) may be provided between adjacent imaged portions in the generation of a second combined imaged portion. The first and second combined imaged portion may be integrated into a single combined imaged portion, or may be used as a “double-check” against one another.

Although the invention is illustrated and described herein with reference to specific methods, the invention is not intended to be limited to the details shown. Rather, various modifications may be made in the details within the scope and range of equivalents of the claims and without departing from the invention.

What is claimed:

1. A method of imaging a feature of a semiconductor device, the method comprising the steps of:
(a) imaging a first portion of a semiconductor device to form a first imaged portion;
(b) imaging a subsequent portion of the semiconductor device to form a subsequent imaged portion;
(c) adding the subsequent imaged portion to the first imaged portion to form a combined imaged portion; and
(d) comparing the combined imaged portion to a reference image of a feature to determine a level of correlation of the combined imaged portion to the reference image of the feature.

2. The method of claim 1 wherein the method is performed using a wire bonding machine, and wherein when the level of correlation is at least a predetermined level then a position of the feature relative to another location of the wire bonding machine is stored in memory.

3. The method of claim 1 wherein steps (b) through (d) are repeated until at least one of: the level of correlation reaches a predetermined level; or steps (b) through (d) have been repeated for a predetermined number of cycles.

4. The method of claim 1 wherein step (b) includes imaging the subsequent portion of the semiconductor device such that the subsequent portion of the semiconductor device is selected by an algorithm.

5. The method of claim 1 wherein the first imaged portion includes an image of a portion of the feature, and wherein step (b) includes imaging the subsequent portion of the semiconductor device such that the subsequent portion is selected to include an image of a further portion of the feature.

6. The method of claim 1 wherein the first imaged portion includes an image of a portion of the feature, and wherein step (b) includes imaging the subsequent portion of the semiconductor device such that the subsequent portion is selected to include an image of the feature.

7. The method of claim 1 wherein step (b) includes imaging the subsequent portion of the semiconductor device such that the subsequent portion is positioned vertically, horizontally or diagonally adjacent the first imaged portion.

8. The method of claim 1 wherein the feature includes an eyepoint of the semiconductor device.

9. The method of claim 1 wherein the feature includes a plurality of bond pads of the semiconductor device.

10. The method of claim 1 wherein step (d) includes comparing the combined imaged portion to the reference image, wherein the combined imaged portion and the reference image each include a plurality of distinct features.

11. The method of claim 1 wherein the feature is larger than a field of view of an imaging system used to perform the method of imaging the feature.

12. A method of imaging a wire loop of a semiconductor device, the method comprising the steps of:
(a) imaging a first portion of a wire loop to form a first imaged portion;
(b) imaging a subsequent portion of the wire loop to form a subsequent imaged portion; and
(c) adding the first imaged portion to the subsequent imaged portion to form a combined imaged portion.

13. The method of claim 12 further comprising a step of determining an amount of wire sway of the wire loop by comparing (i) a location of the wire loop at selected points along the wire loop to (ii) a reference line between a first bond of the wire loop and a second bond of the wire loop.

14. The method of claim 12 wherein the first imaged portion includes a first bond of the wire loop, and wherein steps (b) through (c) are repeated until the combined imaged portion includes a second bond of the wire loop.

15. The method of claim 12 further comprising the step of (d) measuring a height of the wire loop at a location using XY position data of the location provided by the combined imaged portion.

16. The method of claim 12 further comprising the step of displaying the combined imaged portion on a visual display.

17. A method of imaging a semiconductor device, the method comprising the steps of:
(a) imaging a portion of a semiconductor device to form an imaged portion;
(b) imaging a subsequent portion of the semiconductor device to form a subsequent imaged portion;
(c) adding the subsequent imaged portion to the imaged portion to form a combined imaged portion; and
(d) repeating steps (b) through (c) until the combined imaged portion includes an image of an entire side of the semiconductor device.

18. The method of claim 17 wherein the semiconductor device includes a semiconductor die and a substrate for supporting the semiconductor die.

19. The method of claim 17 wherein an illumination of an imaging system used in steps (a) and (b) is varied depending upon which portion of the semiconductor device is being imaged.

20. The method of claim 17 further comprising a step of segregating the semiconductor device into a plurality of sections prior to the imaging in step (a) such that, during imaging in at least one of steps (a) and (b), one of the plurality of sections is imaged.

21. The method of claim 17 further comprising the steps of:
(e) during a bonding process, imaging a portion of another semiconductor device to be wire bonded to form an imaged portion; and
(f) comparing the imaged portion formed at step (e) to the saved combined imaged portion to determine a location of the imaged portion with respect to the saved combined imaged portion.

22. The method of claim 21 further comprising the step of (g) determining a location of an eyepoint of the another semiconductor device using the location of the imaged portion with respect to the saved combined imaged portion.

23. A method of imaging a plurality of portions of a semiconductor device, the method comprising the steps of:
(a) selecting portions of a semiconductor device to be imaged, each of the selected portions including at least one feature, at least one of the selected portions being non-contiguous with others of the selected portions; and
(b) imaging each of the selected portions to form a plurality of selected imaged portions; and
(c) saving each of the plurality of selected imaged portions to form a saved combined imaged portion.

24. The method of claim 23 wherein step (a) includes selecting the portions of the semiconductor device to be imaged such that each of the selected portions includes an eyepoint.

25. The method of claim 23 wherein step (a) includes selecting portions of the semiconductor device to be imaged such that each of the selected portions includes a respective area around the at least one feature.

26. The method of claim 23 wherein at least one of the selected portions to be imaged is larger than a field of view of an imaging system used to perform the method of imaging the plurality of portions.

27. A method of imaging a feature of a semiconductor device, the method comprising the steps of:
(a) imaging a first portion of a semiconductor device to form a first imaged portion;
(b) comparing the first imaged portion to a reference image of a feature to determine a level of correlation of the first imaged portion to the reference image;
(c) selecting a subsequent portion of the semiconductor device based upon the level of correlation of the first imaged portion to the reference image;
(d) imaging the selected subsequent portion of the semiconductor device to form a subsequent imaged portion; and
(e) comparing the subsequent imaged portion to the reference image of the feature to determine a level of correlation of the subsequent imaged portion to the reference image.

28. The method of claim 27 further comprising the step of:
(f) repeating steps (c) through (e) until the level of correlation meets a predetermined level of correlation such that the subsequent imaged portion includes an image of the feature.

29. A method of imaging a feature on a semiconductor device, the method comprising the steps of:
(a) imaging separate portions of a semiconductor device having a feature to form separate imaged portions;
(b) combining the separate imaged portions into a combined imaged portion;
(c) saving the combined imaged portion to form a saved combined imaged portion; and
(d) comparing the saved combined imaged portion to a stored reference image of the feature to establish a level of correlation between the saved combined imaged portion and the stored reference image of the feature to determine if the feature is imaged within the saved combined imaged portion.

30. The method of claim 29 wherein step (a) includes imaging the separate portions of the semiconductor device such that each separate portion corresponds to a field of view of an imaging system.
